(19) United States
(12) Patent Application Publication
(10) Pub. No.: US 2012/0216345 A1
(43) Pub. Date: Aug. 30, 2012

(54) PATIENT TRANSFER DEVICE

(75) Inventor: Barry Hand, Mount Pleasant, SC (US)

(73) Assignee: BERCHTOLD HOLDING GMBH

(21) Appl. No.: 13/034,979

(22) Filed: Feb. 25, 2011

(51) Int. Cl. A61G 7/14

(52) U.S. Cl. 5/85.1

(57) ABSTRACT

The present invention relates to a patient transfer device including an overhead boom connected to a winch comprising a strap, wherein a free length of said strap can be adjusted by means of said winch and an end of said strap is adapted to be connected to a transfer sheet by means of connection means provided at an end of said strap, wherein said transfer sheet is adapted to be moved from a first surface to a second surface by means of an adjustment of said free length

### BACKGROUND OF THE INVENTION

1. Field of the Invention

The invention relates to a patient transfer device for transferring a patient from a first surface to a second surface.

2. The Prior Art

Humans and/or mammals subjected to medical treatment are frequently incapacitated, for example patients can still be anesthetized following an operation or simply be either momentarily or permanently handicapped because of a medical condition. To now ensure a transfer of the patient from the operating table or an examination table to e.g. a hospital bed and/or a stretcher for transport to the hospital bed it is known to use transfer sheets.

Such transfer sheets are generally made of a low friction material or are coated with a low friction material to facilitate the movement thereof. To then move the patient following e.g. a medical procedure which has just been carried out on an operating table in an operating theatre the patient is moved from the operating table to a stretcher by medical practitioners who take a hold of the transfer sheet and then hoist the patient to the stretcher using the transfer sheet. This requires relatively strong medical practitioners and due to the abrupt movements involved can subject the patient to unnecessary pain and also e.g. cause fresh sutures to split open and thereby cause the patient needless harm.

### BRIEF DESCRIPTION OF THE INVENTION

The object of the present invention is to provide an improved transfer device to ensure an effortless transfer of the patient from e.g. an operating table to e.g. a stretcher which transfer device simultaneously reduces the danger of harming the patient.

This object is satisfied in accordance with claim 1. The dependent claims are directed at preferred embodiments of the apparatus in accordance with the invention.

A patient transfer device in accordance with the invention includes an overhead boom connected to a winch comprising a strap, wherein a free length of said strap can be adjusted by means of said winch and an end of said strap is adapted to be connected to a transfer sheet by means of connection means provided at an end of said strap, wherein said transfer sheet is adapted to be moved from a first surface to a second surface by means of an adjustment of said free length.

Since the patient transfer sheet is now attached to a winch via a strap, the medical practitioners no longer have to be physically strong to transfer the patient, but can rather direct their attention towards the patient and ensure a smooth transfer of the patient from the operating table to the stretcher. Moreover, as the winch is connected to an overhead boom the winch can be moved to and from an operating table or a stretcher as required, without having to be installed at the stretcher, which means that all hospital suits having an overhead boom can simply be retrofitted with such a winch device and do not need to replace existing stretchers to facilitate the transfer of a patient.

As present hospital installations can simply be retrofitted with patient transfer devices considerable costs can be saved on implementation thereof. Moreover, as the transfer sheet is now moved by means of a winch rather than by means of the medical practitioner's physical strength a much smoother transfer of the patent can be achieved which is extremely beneficial for the wellbeing of a patient, as no jerky upward and sideways movements arise.

Advantageously a rod is connected to a side of said transfer sheet. This provides the transfer sheet with lateral stiffness in a direction parallel to the patient's body and ensures a smoother transfer of the patient from the first surface to the second surface.

Preferably said rod cooperates with said connection means, so that the strap whose free length is adjusted by means of the winch can be attached to the transfer sheet in a simple and flexible manner and ensure a relatively fast assembly of the transfer device to expedite the patient transfer.

The connection means can be selected from the group comprising a hook, a snap hook and a loop, such devices facilitate a quick connection of the patient transfer device. It should be noted that the transfer sheet is only moved when said first surface is directly adjacent to said second surface, to ensure that e.g. the patient does not fall between the operating table and the hospital bed.

Advantageously said rod causes a substantially equal force distribution along said side of said transfer sheet perpendicular to a direction of movement of said transfer sheet. This force arises due to the length adjustment of the strap and/or in the case of the winch failing a movement of said boom.

Generally speaking said transfer sheet is a low friction transfer sheet composed of material selected from the group including Teflon, Teflon coated materials, nylon, nylon coated materials and/or carbon coated materials. The transfer sheet is generally adapted to transfer a human or an animal patient, such as a horse. Furthermore, the transfer sheet can either be sterilized or is a sterile transfer sheet, so that the patient is not unnecessarily subjected to germs and such like during a medical procedure.

Advantageously, the winch is mounted at a platform. This platform ensures that all devices required to operate the winch can be mounted at one and the same physical position. Moreover, this platform can be aligned adjacent to the second surface to simplify the movement of the transfer sheet to the second surface.

Advantageously said platform is connected to said boom, thereby stabilizing the patient transfer device, as the platform offers a generally larger interface between the winch and the boom than a direct connection between the winch and the boom. Moreover, the platform enables an improved alignment of the winch with respect to the first and second surface.

Advantageously said platform has an abutment surface facing a side of said second surface. Said abutment surface is adapted to be brought into contact with said side to facilitate a stable movement of said transfer sheet from said first surface to said second surface, as the winch positioned on the platform can now be aligned in an improved manner along the second surface. During the reeling in of the strap, i.e. the transfer sheet, the abutment surface provides stability to the overall transfer device.

Advantageously, said platform is adapted to be connected to an equipment column, so that medical devices e.g. required during an operation or a medical examination can be stored in close proximity to the winch and do not require that the patient transfer device be disconnected from the boom during an operation so that a medical professional can utilize the medical devices provided at the equipment column even when the winch is installed there.

Advantageously said first surface or said second surface is one of a hospital stretcher, a hospital bed, an operating table and an examination table. This means that any form of bed typically available in a hospital is capable of being utilized as a first surface and/or a second surface provided that these can be brought into the range of a boom, so that said patient transfer device can be utilized.

Advantageously a movement of said winch which effects said free length adjustment is caused by a drive.

The use of a drive, such as a crank handle, an electric drive, a hydraulic drive or a pneumatic drive, means that a medical practitioner can use even less or absolutely no physical strength to move the patient on the transfer sheet by means of the transfer device in accordance with the present invention.

Advantageously said movement of said transfer sheet is adapted to be actuated by means of a remote control. This has particular advantages when a patient is being moved following a complex operation, as the medical practitioner carrying out the transfer of the patient from the first surface to the second surface can now simply monitor the movement and the well being of a patient at the same time as he/she controls control the movement of the patient while also monitoring the patient's status.

In an embodiment said remote control is provided at said platform. In a further embodiment said remote control is provided at said boom. A remote control stored at either the boom, the platform or even the winch is stored away for easy reach and is then always available when using that piece of equipment.

The remote control can have a wireless interface via which it communicates with the winch. Alternatively it could be directly connected to the platform/winch device to prevent any miscommunications with other medical devices present in the surrounding space taking place. The remote control can advantageously have a control which controls the speed of transfer of the patient. The remote control can also be coupled to the boom to adjust the height of the winch device relative to the first and second surface.

In an embodiment a vertical arm is connected between said boom and said winch. This vertical arm allows a vertical alignment of said winch with respect to the horizontal upper surfaces of said surfaces. Moreover, it enables said winch to be used with any overhead boom as advantageously the length of said vertical arm is simply selected for the appropriate height of the hospital ward.

Advantageously said boom has at least one horizontal arm, i.e. a one-armed boom, a two-armed boom or even a three-armed boom can be used in the apparatus in accordance with the invention.

The advantageous features of the invention are described in an exemplary manner only and are not intended to restrict the inventive apparatus in any way or form.

The invention will be described in the following with regard to further features and advantages by way of examples with reference to embodiments in the enclosed drawings.

### BRIEF DESCRIPTION OF THE DRAWINGS

FIG. 1 a schematic side view of an embodiment of the patient transfer device in accordance with the invention;

FIG. 2A a schematic top view of a further embodiment of the invention in a first position;

FIG. 2B a top view of the embodiment of FIG. 2A in a second position;

FIG. 3 a further embodiment depicting part of the components of a patient transfer device in accordance with the invention;

FIG. 4 a schematic representation of a medical column attached to a boom; and

FIG. 5 a further schematic representation of a medical column attached to a boom.

Features having the same or similar function will be described in the following using the same reference numerals.

### DETAILED DESCRIPTION

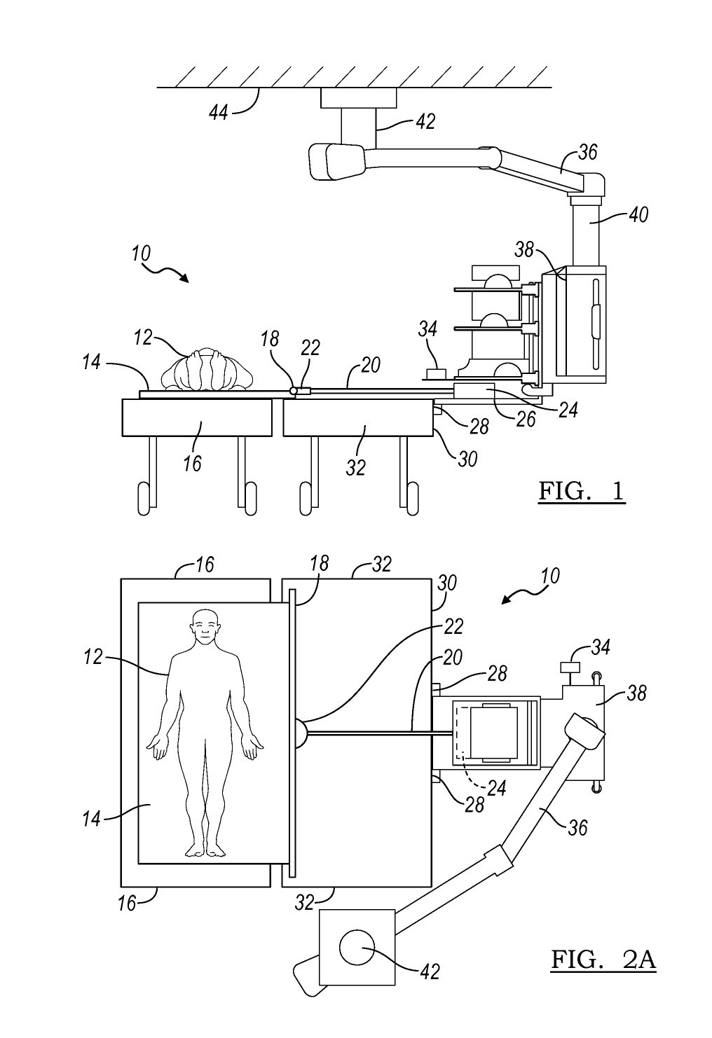

FIG. 1 shows a schematic side view of a patient transfer device 10. A patient 12 is currently positioned on a low friction transfer sheet 14 on an operating table 16. Attached to the transfer sheet 14 is a rod 18 connected to a strap 20 via a hook 22. The strap 20 is adapted to be wound up onto a winch 24 placed on a platform 26. An abutment surface 28 of the platform 26 is contacting a side 30 of a hospital stretcher 32 via the abutment surface 28 to impart stability to the transfer device 10 when the strap 20 included in the winch 24 is wound up or reeled in by the winch 24 to transfer the patient 12 from the operating table 16 to the stretcher 32.

A remote control 34 is attached to the platform 26 by means of which the winch 24, of the patient transfer device 10, can be actuated. The remote control 34 can either be a wireless remote control 34 or be connected directly to the platform 26. The remote control 34 can control and regulate the speed at which the winch 24 reels in the strap 20 and for this reason can control the speed of movement of the strap 20. In a different embodiment the remote control 34 can also be attachable to the boom 36.

Attached to the platform 26 is an equipment column 38, which can include medical devices such as scalpels, pincers and such like (not shown) and/or be adapted to include medical devices required to monitor a patient's condition (also not shown) e.g. the heart rate and breathing rate of a patient 12 during anesthesia or a different medical procedure. A vertical arm 40 is connected between the two-armed boom 36 suspended from a ceiling via a pivot point 42 and the platform 26. Preferably the vertical position of the platform 26 connected to the vertical arm 40 can be adjusted relative to the vertical arm 40. Preferably the change in vertical position of the platform 26 can be actuated by means of the remote control 34.

On activation of the winch 24 the strap 20 connected between the winch 24 and the rod 18 is wound up within the winch device 24, i.e. a free length of the strap 20 is reduced to facilitate the movement of the transfer sheet 14 from the operating table 16 to the hospital stretcher 32. This is generally carried out following a medical procedure to move the patient 12 out of the operating theatre to e.g. a wake-up room or to a hospital ward for post-operative treatment (not shown).

As the strap 20 is connected to the transfer sheet 14 by means of a hook 22 connected to the rod 18 this can simply be released 5 from the rod 18 following the transfer of the patient 12. Alternatively the hook 22 can simply be connected to the rod 18 to carry out with the transfer of the patient 12. As the winch 24 is mounted to a platform 26 connected to the boom 36 this can be moved to and fro in the hospital room according to the maximum range available to the boom 36, preferably such that the stretcher 32 and/or the operation table 16 can be moved past the winch device 24 and out of the operating theatre when required.

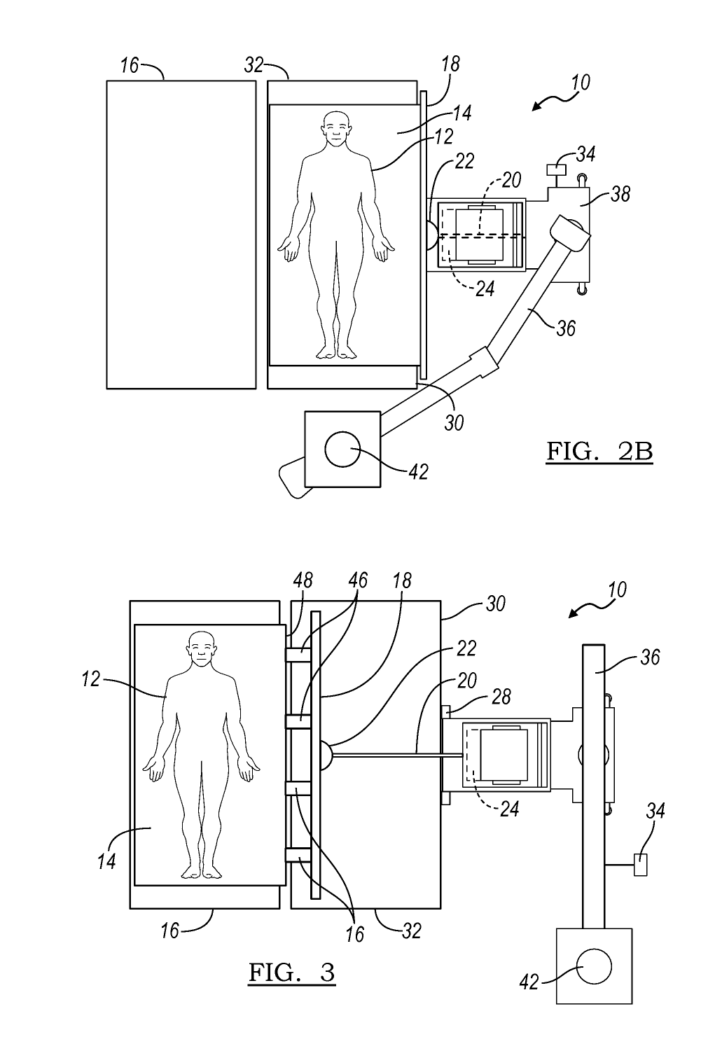

FIG. 2A shows a further embodiment in which a loop 22 is provided as a connection means 22 to connect the strap 20 to the rod 18 connected to the transfer sheet 14. The transfer device 10 is in a first position, i.e. in a position where the patient 12 is still on the examination table 16 and is about to be moved to a hospital bed 32 by means of the transfer sheet 14 lying between the patient 12 and the examination table 16.

FIG. 2B shows the patient 12 now lying on the hospital bed 32 having been moved from the examination table 16 by means of the transfer device 10. For this purpose the free length of the strap 20 has been reduced by means of the winch 24 to move the transfer sheet 14, and hence the patient 12, from the examination table 16 to the hospital bed 32. The equipment column 38 shown in the embodiment of FIGS. 2A and 2B also acts at the connection between the boom 36 and the platform 26.

FIG. 3 shows a further embodiment in which the rod 18 is connected to the transfer sheet 10 via four loops 46 simply sewn into a side 48 of the transfer sheet 14. This is particularly beneficial as this allows the rod 18 to be removed from the transfer sheet 14 during the medical procedure to improve the access to the patient 12 during the procedure. Following the procedure the rod 18 is simply placed through the four loops 46 to ensure a smooth transfer of the patient 12 from the operating table 16. Naturally a plurality of loops 46 can be attached to the side 48 of the transfer sheet 14 (not shown), or a single passage can be formed by one loop 46 along the complete side 48 of the transfer sheet 14, to allow the introduction and removal of the rod 18 (see e.g. FIG. 1). Moreover, the rod 18 is connected to the free length of the strap 20 via a snap-on hook 22. A snap on hook 22 ensures a fast and reliable connection between the rod 18 and the free length of the strap 20.

In the embodiment of FIG. 3 a one-armed boom 36 is used. The vertical arm 40 connecting the platform 26 to the winch 24 is attached to the boom 36 via a boom trolley (not shown) which is adapted to move to and fro along the length of the boom 36. This permits the movement of the platform 26 and thus the patient transfer device 10 in a desired manner throughout the hospital room.

The rod 18 connected to the low friction transfer sheet 14 is preferably made of from a relatively strong light weight material, such as aluminum, glass fiber or wood coated with a plastic coating, provided the material is suitable for deflecting the loads arising due to the movement of the patient 12 from a first surface 16 to the second surface 32. The winch 24 used is preferably a winch driven by an electronic drive (not shown), so that a step-less transition of the patient 12 can be ensured. The strap 20 connecting the winch 24 to the rod 18 is either a leather strap 20, a strap 20 made of plastic material or such like.

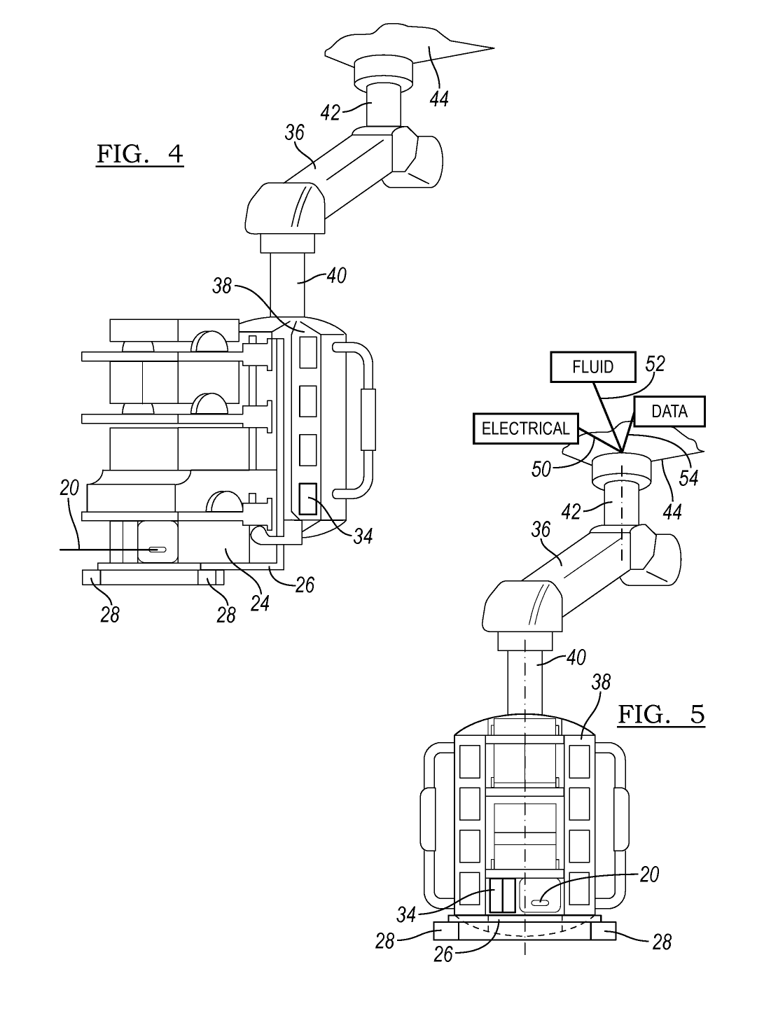

FIG. 4 shows the winch 24 attached to the bottom of the equipment column 38 which has an assortment of trays provided in which medical tools such as scalpels, syringes, clamps and other medical devices required by a surgeon during an invasive procedure can be stored. In this embodiment the platform 26 has two abutment surfaces 28 attached to its end which faces the second surface 32 during the transfer of a patient 12 following the medical procedure.

FIG. 5 shows an example in which the winch 24 is integrated into an equipment column 38 in which the platform 26 is formed by the base of the equipment column 38, adjacent to the base 26 of the equipment column 38 are two metal surfaces 28 which act as the abutment surfaces 28. As can be seen from FIG. 5 the pivot point 42 of the single armed boom 36 acts as a cable passage for electrical cables 50, which provide power to the medical column, fluid cables, which can provide fluids required for the wellbeing of a patient during an operation, and data lines 52 for storing medical data associated with a patient 12 and measured during an operation with the monitoring equipment stored in the equipment column 38.

In both of the examples of an equipment column 38 shown in FIG. 4 and in FIG. 5 the winch 24 is integrated into the equipment column 38 and can be actuated via the remote control 34 incorporated with the platform 26 at the equipment column. The abutment surfaces 28 of the equipment columns 38 of FIGS. 4 and 5 are both adapted to contact a side 30 of the second surface 32 to stabilize the transfer of a patient using the patient transfer device 10.

1. A patient transfer device including an overhead boom connected to a winch comprising a strap, wherein a free length of said strap can be adjusted by means of said winch and an end of said strap is adapted to be connected to a transfer sheet by means of connection means provided at an end of said strap, wherein said transfer sheet is adapted to be moved from a first surface to a second surface by means of an adjustment of said free length.

2. A patient transfer device in accordance with claim 1 wherein a rod is connected to a side of said transfer sheet.

3. A patient transfer device in accordance with claim 2 wherein said rod cooperates with said connection means.

4. A patient transfer device in accordance with claim 2 wherein said rod causes a substantially equal force distribution along said side of said transfer sheet perpendicular to a direction of movement of said transfer sheet.

5. A patient transfer device in accordance with claim 1 wherein said winch is mounted at a platform.

6. A patient transfer device in accordance with claim 5 wherein said platform is connected to said boom.

7. A patient transfer device in accordance with claim 5 wherein said platform has an abutment surface facing a side of said second surface.

8. A patient transfer device in accordance with claim 7 wherein said abutment surface is adapted to be brought into contact with said side.

9. A patient transfer device in accordance with claim 5 wherein said platform is adapted to be connected to an equipment column.

10. A patient transfer device in accordance with claim 1 wherein said first surface or said second surface is one of a hospital stretcher, a hospital bed, an operating table and an examination table.

11. A patient transfer device in accordance with claim 1 wherein a movement of said winch which effects said free length adjustment is caused by a drive.

12. A patient transfer device in accordance with claim 1 wherein said movement of said transfer sheet is adapted to be actuated by means of a remote control.

13. A patient transfer device in accordance with claim 13 wherein said remote control is provided at said platform.

14. A patient transfer device in accordance with claim 13 wherein said remote control is provided at said boom.

15. A patient transfer device in accordance with claim 1 wherein a vertical arm is connected between said boom and said winch.

16. A patient transfer device in accordance with claim 1 wherein said boom has at least one horizontal arm.
